(19) United States
(12) Patent Application Publication
(10) Pub. No.: US 2002/0012007 A1
(43) Pub. Date: Jan. 31, 2002

(54) Internet based design/drafting system and method of use thereof

(76) Inventor: John M. Twigg, Pittsburgh, PA (US)

Correspondence Address: Randall A. Notzen, 700 Koppers Building, 436 Seventh Avenue, Pittsburgh, PA, 15219-1818, US

(21) Appl. No.: 09/849,758

(22) Filed: May 4, 2001

Related U.S. Application Data
(60) Provisional application No. 60/202,236, filed on May 5, 2000.

(51) Int. Cl. G09G 5/00

(52) U.S. Cl. 345/677

(57) ABSTRACT

A server computer stores a database having a plurality of design files. A client computer selects one of the design files from the database at the server computer via the Internet. In response to this selection, the server computer instantiates in a memory thereof a copy of the selected design file. The server computer then determines in memory where the connection point of a feature represented by one object of the design file is coincident with or closely adjacent a connection point of another feature represented by another object of the design file. Once the connection points are made coincident or closely adjacent, the features represented by the objects are displayed on the display of the client computer with the connection points coincident or closely adjacent.

### CROSS REFERENCE TO RELATED APPLICATIONS

This application claims priority from U.S. Provisional Patent Application Ser. No. 60/202,236, filed May 5, 2000, entitled “Web-Based, Fully-Automated, Design Drafting System”.

### BACKGROUND OF THE INVENTION

1. Field of the Invention

The present invention relates to generating computer aided design (CAD) drawings over the Internet.

2. Description of the Prior Art

Many engineering disciplines utilize drawings to record and communicate ideas regarding a design and/or features of a design. Presently, CAD drawing systems are utilized by skilled draftspersons to create and modify drawings. A problem with existing CAD drawing systems, is that labor is required to effect even minor changes in the drawings related to a design. To this end, it has been estimated that drawing production costs consume approximately 60% to 75% of the engineering costs related to a design.

In order to remain competitive, industries, such as engineering, utility, construction and manufacturing companies, are constantly striving to reduce capital, operating and personnel costs while increasing quality and decreasing time to market. One way to reduce these costs is to reduce the labor time to prepare or modify a drawing or drawings related to a design or features of a design. However, heretofore, no effective means existed for reducing this labor time.

It is, therefore, an object of the present invention to overcome the above problem and others by providing an Internet based system and method for generating new design drawings or modified design drawings from a database of predetermined designs. Still other objects will become apparent to those of ordinary skill in the art upon reading and understanding the following detailed description.

### SUMMARY OF THE INVENTION

Accordingly, I have invented a design/drafting method implemented between a client computer and a server computer connected to each other via the Internet. The method includes providing at a server computer a database having a plurality of design files, with each design file including a plurality of classes, with each class representing a feature of a design represented by the corresponding design file. A user at a client computer can select via the Internet a design file from the database at the server computer. The server computer instantiates in the memory thereof from the plurality of classes in the database for the select design a plurality of objects including a reference object and at least one connector object. Each object includes at least two connection points for the feature represented thereby. In the memory of the server computer, a determination is made where one of the connection points of the connector object is coincident with or closely adjacent one of the connection points of the reference object. Lastly, a drawing of the design with the one connection point of the connector object coincident or closely adjacent the one connection point of the reference object is displayed on a display of the client computer as a function of the reference object and the connector object.

The method can also include the steps of converting each object in memory from a first type to a second type and transferring the objects of the second type from the memory of the server to the client computer. The client computer processes the objects of the second type received thereby and the features represented by the second type objects of the reference object and the connector object are displayed on the display of the client computer.

The drawing of the design can include for the reference object and the connector object the first drawing part and the second drawing part, respectively. The first and second drawing parts are positioned relative to each other in the drawing as a function of the server computer determining where the one connection point of the connector object is coincident with or closely adjacent the one connection point of the reference object.

Another object can be instantiated in memory and a determination can be made where another connection point of the connector object is coincident with one connection point of the other connector object. A drawing of the design can be generated from the reference object, the connector object and the other object, with the other connection point of the connector object coincident with the one connection point of the other connector object.

The drawing of the design can include for the reference object, the connector object and the other object, a first drawing part, a second drawing part and a third drawing part, respectively. The first, second and third drawing parts are positioned relative to each other in the drawing as a function of the server computer determining where the one connection point of the connector object is coincident with the one connection point of the reference object and where the other connection point of the connector object is coincident with the one connection point of the other connector object.

The reference object and each connector object can include a plurality of invariable data related to an invariable trait of the corresponding feature of the drawing. At least one of the connector objects can include at least one variable data related to a variable trait of the corresponding feature of the drawing. The variable data can relate to, for example, a length or height of the feature generated from one of the connector objects.

The server computer can receive from the client computer via the Internet a change in the variable data of the trait of the reference object or one of the connector objects. The drawing of the design can be displayed with the second or third drawing including a feature having a trait varied in accordance with the change in the variable data.

I have also invented a server computer connectable to the Internet. The server computer includes a database of design files, with each design file including a plurality of classes. The server computer includes a processing routine for receiving from the Internet the selection of one design file from the database. The processing routine instantiates from the plurality of classes for the selected design file a plurality of objects, with each object representing a feature of a design represented by the selected design file and with each object having a plurality of connection points for the feature. The processing routine also determines for the feature represented by each object where at least one connection point is coincident or closely adjacent a connection point of the feature represented by another object. The server computer also includes a data transfer routine for transferring to the Internet the data related to each object for display of a drawing including the features represented by the objects, whereby the features represented by the objects are arranged to form the drawing with at least one connection point of each feature connected to or closely adjacent a connection point of another feature as a function of the coincidence of close adjacency of the connection points in the corresponding objects representing the features.

The processing routine can also be configured to modify a connection point of an object that is not coincident with the connection point of another object so that their connection points are coincident in the display of the drawing.

The processing routine can receive via the Internet change data for modifying a trait of one of the objects. In response to receiving the change data, the processing routine changes data of the one object to effect a change in the trait thereof. As a result of this change in the data of the one object, the drawing includes the feature represented by the one object with the trait varied in accordance with the change data. This change data can modify a length and/or a height of the feature represented by the one object.

Each design file further includes alpha, numeric and/or alphanumeric data related to at least one feature represented by one of the objects. The data transfer routine transfers to the Internet the alpha, numeric and/or alphanumeric data related to the at least one feature represented by one of the objects of the design file.

Lastly, I have invented a client computer connectable to the Internet. The client computer includes an interface routine for selecting via the Internet one of a plurality of predetermined design files. Each design file includes a plurality of objects, with each object representing a feature of the design represented by the design file. The interface routine receives from the Internet in response to the selection of the design file a first set of objects and selects from the Internet one or more modifications to the design file. The interface routine transmits the one or more modifications to the Internet and receives from the Internet in response thereto a second set of objects representing features of the design file with at least one object of the second set modified as a function of the one or more transmitted modifications. The client computer includes a display routine for displaying a menu of the plurality of predetermined design files used by the interface routine for selecting the one predetermined design file. The display routine also displays a first drawing including the features of the selected design file from the first set of objects received from the Internet. The display routine also displays a menu used by the interface routine for selecting the one or more modifications to the selected design file and displays a second drawing of the features of the selected design file from the second set of objects received from the Internet, with at least one feature of the second drawing modified from the first drawing as a function of the selected one or more modifications.

The selected design file can include alpha, numeric and/or alphanumeric data related to one or more features of the first and/or second drawings displayed by the display routine. The display routine can display a menu used by the interface routine for selecting the alpha, numeric and/or alphanumeric data related to the selected design file to be displayed thereby. The alpha, numeric and/or alphanumeric data can include at least one of a description, a note and a cost related to one or more features of the design file.

Each feature of the design represented by the design file includes at least two connection points. The display routine displays the features of the design file with one connection point of each feature coincident or closely adjacent a connection point of another feature.

### BRIEF DESCRIPTION OF THE DRAWINGS

FIG. 1 is a block diagram of a server computer connected to a plurality of client computers via the Internet;

FIG. 2 is a block diagram of hardware and design files of the server computer shown in FIG. 1;

FIG. 3 is a detailed block diagram of two exemplary design files stored in a database of the server shown in FIG. 1;

FIG. 4 is a detailed block diagram of the structure of one of the classes of the design files shown in FIG. 3;

FIG. 5a is a block diagram of one of the design files of FIG. 3 instantiated in a memory of the server computer;

FIG. 5b is a block diagram of a vector graphics file generated from the design file shown in FIG. 5a and stored in a memory of the server computer;

FIGS. 6-8a are exemplary screen displays that are displayed on the display of one of the client computers shown in FIG. 1;

FIG. 8b is an enlarged isolated view of the drawing shown in the screen display of FIG. 8a;

FIG. 8c is an isolated exploded view of three features, or components, of the drawing of FIG. 8b;

FIGS. 9 and 10a are exemplary screen displays that are displayed on the display of one of the client computers shown in FIG. 1;

FIG. 10b is an enlarged isolated view of the drawing shown in the screen display of FIG. 10a; and

FIGS. 11-14 are exemplary screen displays that are displayed on the display of one of the client computers shown in FIG. 1.

### DETAILED DESCRIPTION OF PREFERRED EMBODIMENTS

The present invention will be described in connection with the design of a plumbing/piping system for use of distribution of natural gas. However, it is to be appreciated that the present invention also finds application in connection with any type of design having one or more features or traits that can be varied in accordance with one or more predetermined design rules. The present invention will now be described with reference to the accompanying drawings where like reference numbers correspond to like elements.

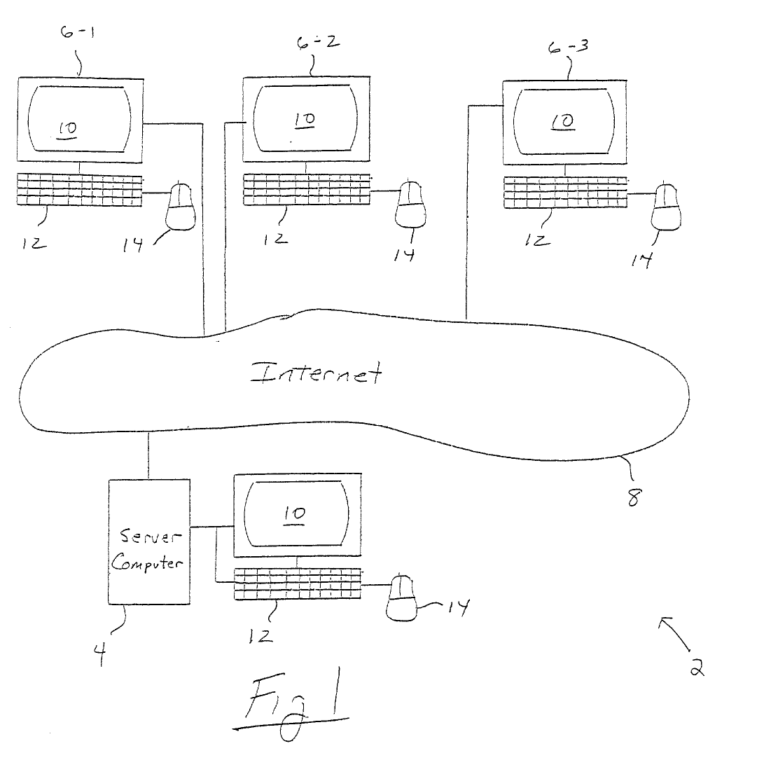

With reference to FIG. 1, a system 2 in accordance with the present invention includes a server computer 4 configured to communicate with one or more client computers 6-1, 6-2, 6-3, etc., via the Internet 8 in a manner known in the art. Server computer 4 and each client computer 6 includes a display 10, a keyboard 12 and a mouse 14 which collectively act as an interface between users of server computer 4 and each client computer 6.

Server computer 4 operates under the control of server software and each client computer 6 operates under the control of client software. The server software and the client software are configured to cause server computer 4 and each client computer 6 to implement the present invention. More specifically, the server software, running on server computer 4, and the client software, running on each client computer 6, are configured to interact in a manner to be described in greater detail hereinafter to realize the system and method of the present invention.

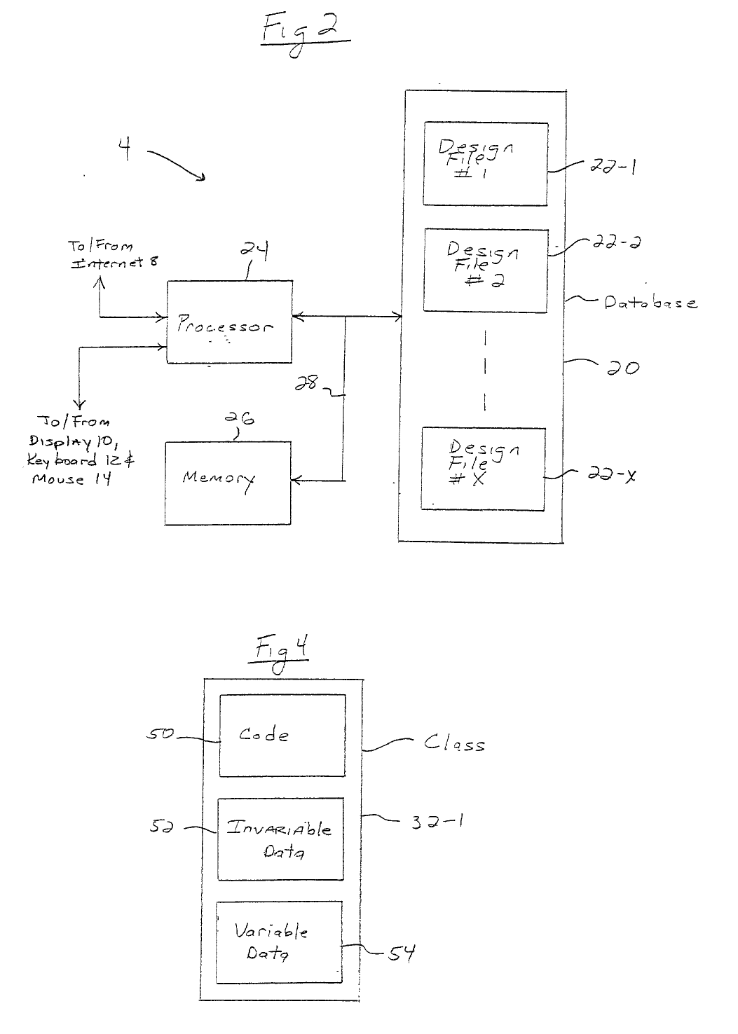

With reference to FIG. 2, and with continuing reference to FIG. 1, server computer 4 includes a database 20 which stores a plurality of design files 22-1, 22-2, . . . 22-x. Database 20 is preferably stored on a magnetic or optical storage medium (not shown) of server computer 4. Server computer 4 also includes a processor 24 which operates under the control of the server software which resides in a memory 26 of server computer 4. Database 20, processor 24 and memory 26 are operatively connected together via a bus 28 in a manner known in the art.

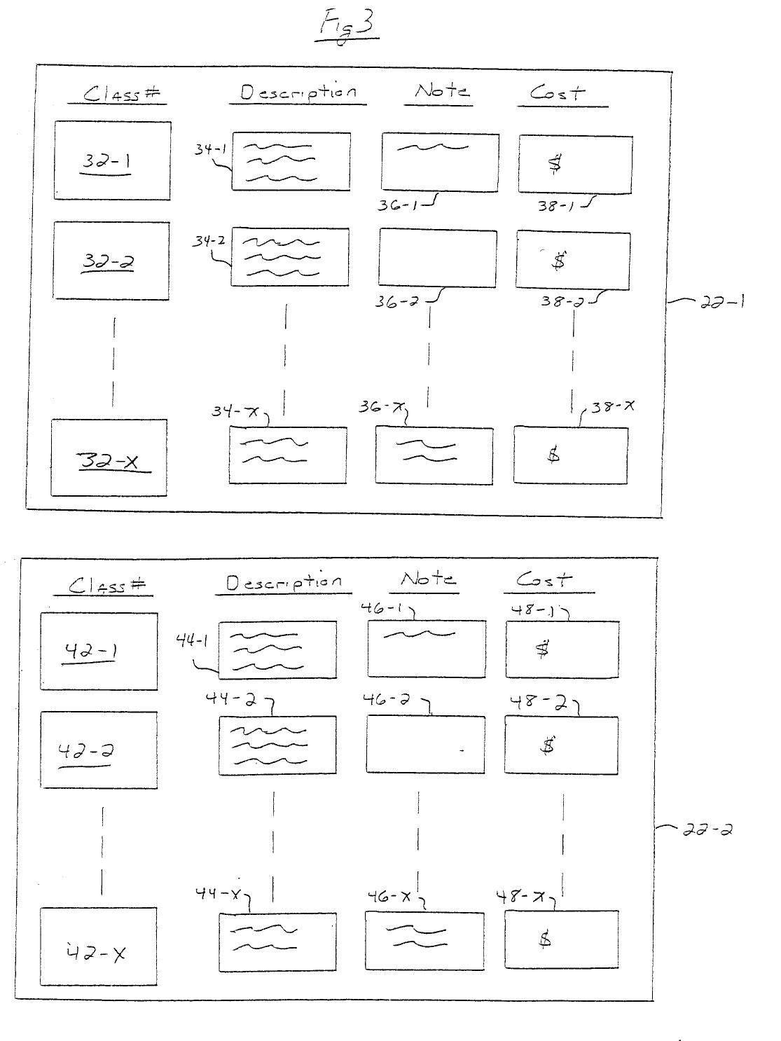

With reference to FIG. 3, and with continuing reference to FIGS. 1 and 2, each design file 22 stored in database 20 preferably includes a plurality of classes or templates 32, 42 known in the art of object oriented programming. Each class 32, 42 includes the necessary code and data for enabling the server software and the client software to coact and render a two-dimensional visual display of a feature or trait of a component design represented by the design file 22. Each design file 22 also includes for each class 32, 42 data fields 34, 36, 38, 44, 46, 48 for receiving alpha, numeric and/or alphanumeric data related to the feature represented by the corresponding class 32, 42. This data can include, without limitation, description data, note data, cost data, etc. For example, as shown in FIG. 3, design file 22-1 includes classes 32-1, 32-2, . . . , 32-x related to different features or traits of the design represented by design file 22-1. Associated with class 32-1 is a description data field 34-1, a note data field 36-1 and a cost data field 38-1. Preferably, description data field 34-1 and note data field 36-1 are each configured to receive alpha and/or numeric data regarding the feature represented by class 32-1. Cost data field 38-1 is configured to receive numeric data regarding the acquisition cost of the feature represented by class 32-1. Similar comments apply in respect of the description data field 34, the note data field 36 and the cost data field 38 associated with each remaining classes 32-2, . . . , 32-x of design file 22-1. Similarly, design file 22-2 includes a plurality of classes 42-1, 42-2, . . . , 42-x with each class 42 having associated therewith a unique description data field 44, note data field 46, cost data field 48, etc. Similar comments apply in respect of each design file 22 stored in database 20. Alternatively, one or more of note data fields 36, 46 of each design file 22 can be related to the overall design and unrelated to a particular class 32, 42, description field 34, 44 or cost field of 38, 48.

With reference to FIG. 4 and with continuing reference to all previous Figs., each class, e.g., 32-1, stored in database 20 includes code 50 and invariable data 52 which together define the traits of the feature represented by the class which can be rendered as a two-dimensional drawing which is part of an overall larger drawing represented by the design file 22 that includes its class. Examples of invariable data 52 can include an inside diameter of a pipe, an outside diameter of a pipe, the dimensions of a regulator, the dimensions of a plug valve, and the like, of a plumbing/piping system.

One or more of the classes of each design can also include variable data 54 which can be varied to affect a change in a trait of the feature represented by the class. Preferably, any variable data 54 included in a class, e.g., 32-1 of a design file, e.g., 22-1, is initialized to a starting value, and each class including variable data is configured so that the variable data included therein can be modified in response to receiving a suitable instruction directing modification of the variable data. It is to be appreciated that the variable data can be represented by one or more fields of data, each of which can be modified independently. Each data field associated with the variable data preferably represents a trait of the feature represented by the object including the variable data. Thus, for example, in response to receiving a suitable instruction, the variable data in a variable data field related to a length of a pipe can be modified so that the length of the pipe rendered as part of a drawing represented by the design file 22 can be changed as desired for a particular design.

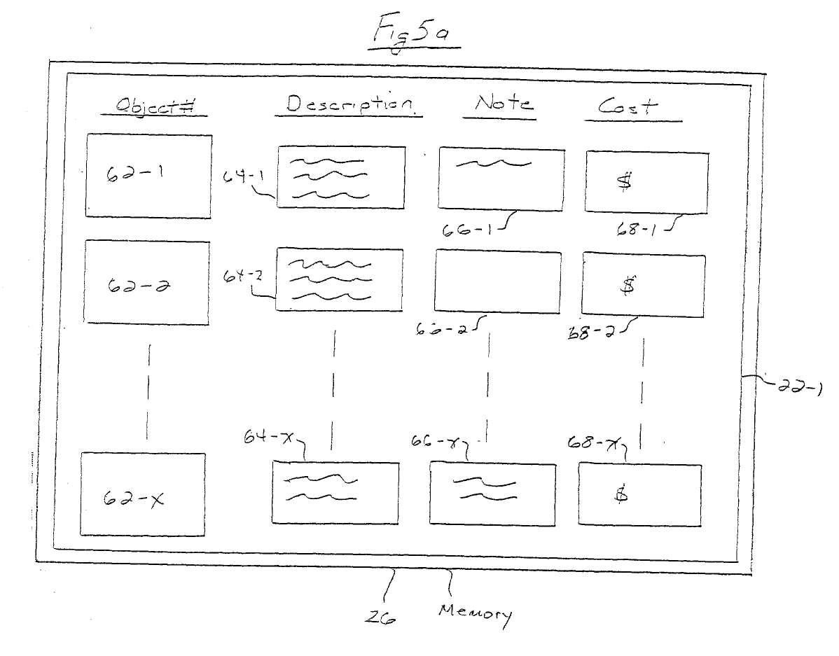

With reference to FIG. 5a, and with continuing reference to all previous Figs., when a user stationed at a client computer 6 selects a design file 22 stored in database 20, the server software causes processor 24 to create in memory 26 an instance of each class of the design file 22. Thus, for example, if the user selects design file 22-1, processor 24 creates an instance of each class 32-1, 32-2, . . . , 32-x as an object 62-1, 62-2, . . . , 62-x, respectively, in memory 26. In addition, processor 24 creates in memory 26 a copy of the various data fields associated with the design. Thus, for example, processor 24 copies data fields 34, 36 and 38 associated with each class of design file 22-1 into memory 26 as data fields 64, 66 and 68. Once an instance of design file 22-1 has been created in memory 26, processor 24 processes the objects 62-1, 62-2, . . . , 62-x in accordance with the server software.

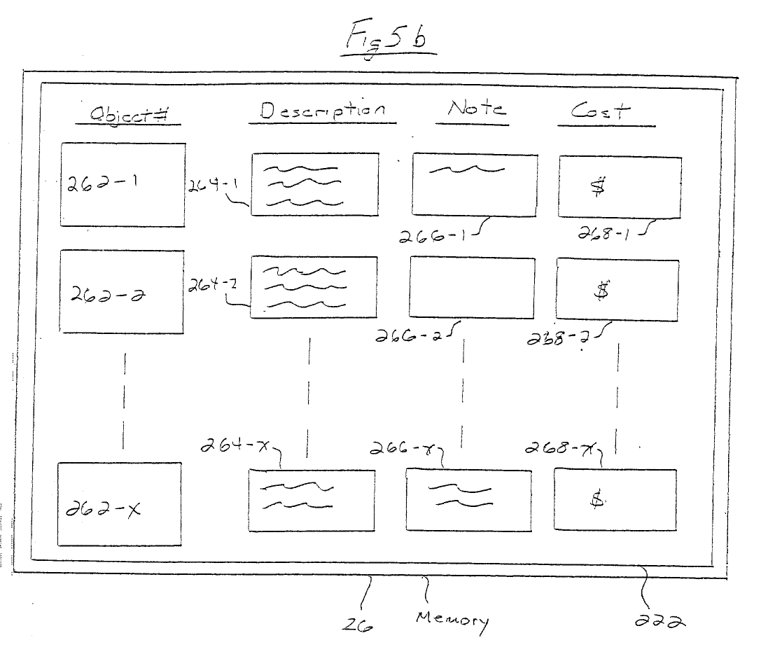

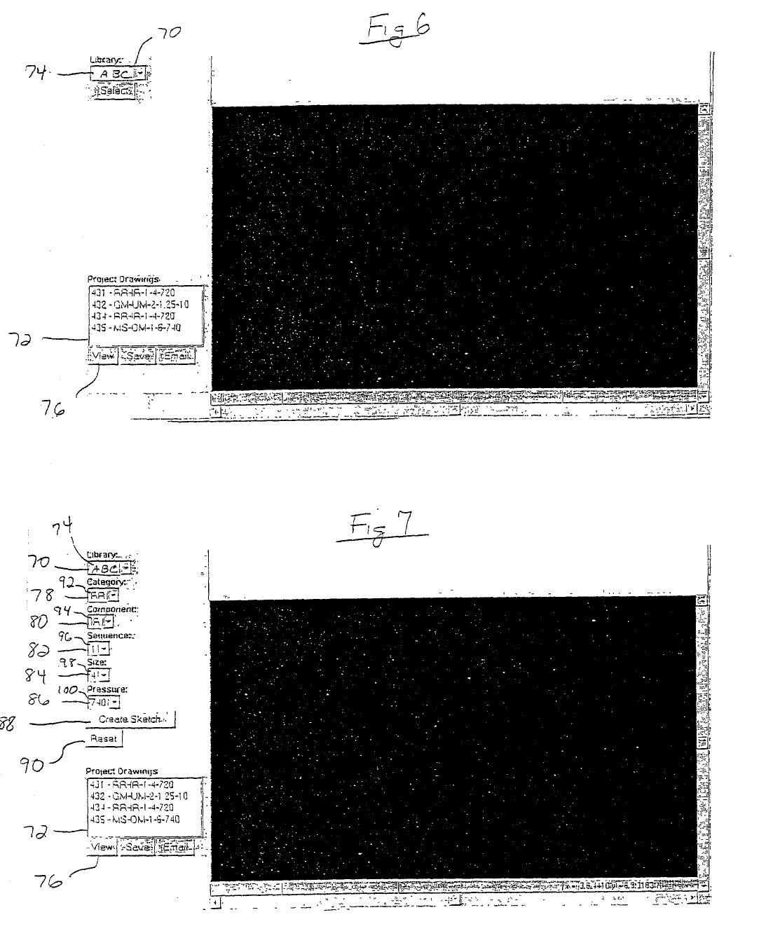

The steps taken by the client software to select a particular design file 22 and to receive a corresponding processed design file (discussed hereinafter) from the server computer 4, and the steps taken by the server software to receive the request for the particular design file 22 from the requesting client computer 6 and to forward the corresponding processed design file thereto for display will be described next with reference to FIGS. 6-8C.

Utilizing the client software installed on client computer 6, a user logs into server computer 4 by entering a user I.D. and password into data fields of a logon screen (not shown) displayed on display 10 of client computer 6. Login screens of the type utilized by a user of a client computer 6 to log onto to the server software residing on server computer 4 are well-known in the art and, therefore, have not been included for simplicity. In addition, the user can access various project tracking screens (not shown) which include data received in one or more fields thereof from the user and/or from server computer 4. For purpose of simplicity, these project tracking screens have also not been included.

Eventually, display 10 of client computer 6 displays the screen shown in FIG. 6 including a library pull down menu 70 and a Project Drawings field 72 for displaying a descriptive file name associated with one or more design files 22 stored in a library of database 20 displayed in a display field 74 of library pull down menu 70. To view an existing design, the user selects one of the file names appearing in the Project Drawings field 72 and selects a View button 76.

Alternatively, instead of reviewing an existing design, the user can select in the project tracking screen (not shown) to create a new design. In response to making this selection, the client software displays the library pull down menu 70 and the Project Drawings field 72 shown in FIG. 6. In addition, as shown in FIG. 7, for a design of a natural gas piping/plumbing system, the client software preferably displays a Category pull down menu 78, a Component pull down menu 80, a Sequence pull down menu 82, a Size pull down menu 84 and a Pressure pull down menu 86. In addition, the client software displays a Create Sketch button 88 and a Reset button 90. Each of pull down menus 78-86 includes a display field 92-100, respectively, for displaying the selection chosen from the corresponding pull down menu. The selections in each pull down menu 70 and 78-86 are supplied to the client software by the server software via the Internet 8. The choice of the selections in pull down menus 78-86 corresponds to the selection of a particular design file 22 in database 20. Once a particular design file 22 in database 20 has been selected, the user selects Create Sketch button 88.

An indication that the user has selected a particular design file 22 is transferred from client computer 6 to server computer 4. In response to receiving this indication, server computer 4 creates an instance of, or instantiates, the selected design file 22 in memory 26. For example, if the user selects design file 22-1, processor 24 creates an instance of design file 22-1 in memory 26 as shown in FIG. 5a.

The server software includes a software layer which processes the objects 62, descriptions 64, notes 66 and costs 68 of design file 22-1 received in memory 26 into a vector graphics file 222, shown in FIG. 5b, or other such graphics file, which the client software can utilize to display the design represented by design file 22-1 on display 10 of client computer 6. This vector graphics file 222, like design file 22-1, is stored in memory 26 and includes a first set of objects 262 which includes an object 262-1, 262-2, . . . , 262-x for each feature to be rendered on display 10 of client computer 6. In addition, this vector graphics file 222 can include for each object 262-1, 262-2, . . . , 262-x: a description data field 264-1, 264-2, . . . , 264-x; a note data field 266-1, 266-2, . . . , 266-x; and/or a cost data field 268-1, 268-2, . . . , 268-x, respectively, for the feature represented by the object. The description data in description data fields 64-1, 64-2, . . . , 64-x can be received in description data fields 264-1, 264-2, . . . , 264-x; the note data fields in note data fields 66-1, 66-2, . . . , 66-x can be received in the note data fields 266-1, 266-2, . . . , 266-x; and the cost data in cost data fields 68-1, 68-2, . . . , 68-x can be received in cost data fields 268-1, 268-2, . . . , 268-x. From a block diagram standpoint, vector graphics file 222 has block elements similar to the block elements of design file 22-1 received in memory 26 from database 20. The objects 262-1, 262-2, . . . , 262-x associated with vector graphics file 222, however, are typically larger than objects 62-1, 62-2, . . . , 62-x of design file 22-1 received in memory 26 from database 20. This is because each object 262 of vector graphics 222 contains sufficient code and data to enable the client software to render the feature represented by the object 262 on display 10 of the user's client computer 6. Once this vector graphics file 222 is created, the server software transfers vector graphics file 222, including the first set of objects 262, to the client software running on client computer 6.

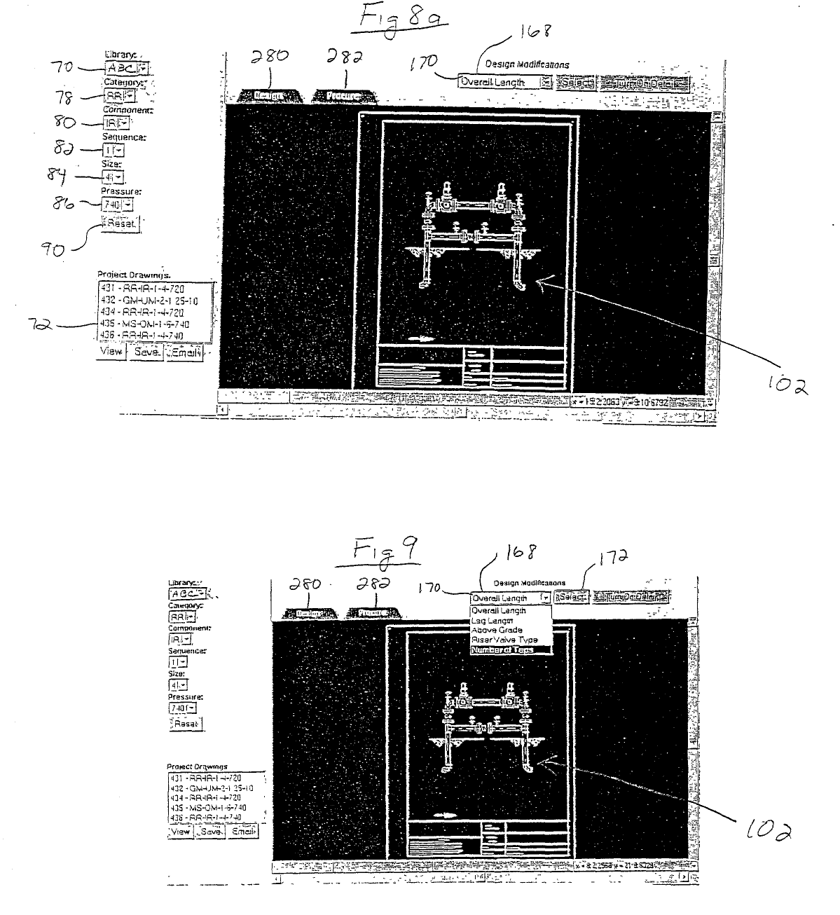

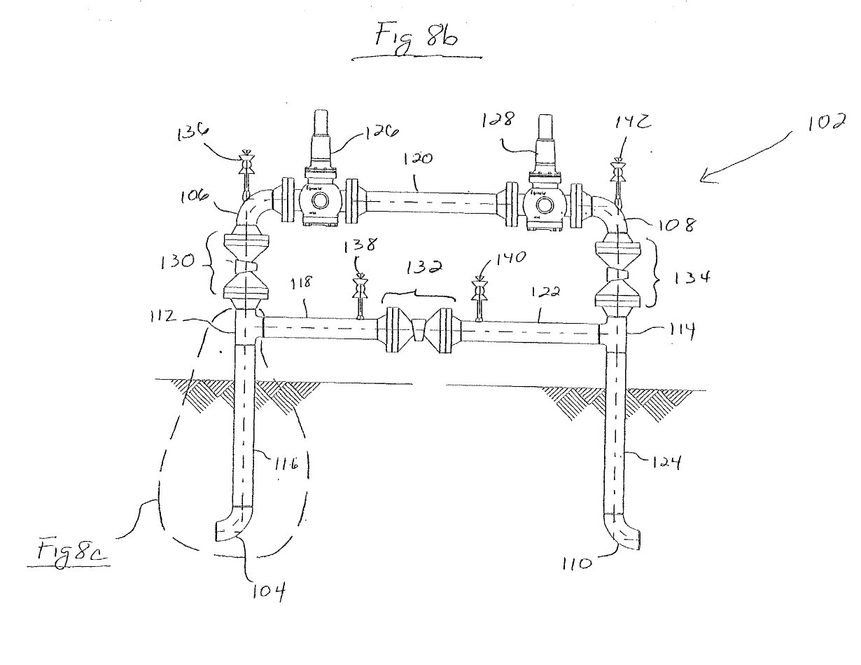

With reference to FIG. 8a, and with continuing reference to all previous Figs., the client software is configured to process vector graphics file 222 to produce therefrom on display 10 of client computer 6 a drawing 102 of the piping/plumbing system represented in design file 22-1 selected by the user in pull down menus 78-86.

With reference to FIG. 8b, and with continuing reference to all previous Figs., drawing 102 is formed from a plurality of features that have been arranged in an appropriate form to produce the piping/plumbing system represented in design file 221 selected by a user of client computer 6. Each feature represents a component of the selected piping/plumbing system. These features include elbows 104, 106, 108 and 110; tees 112 and 114; pipes 116, 118, 120, 122, and 124; regulators 126 and 128; plug valves 130, 132 and 134; and tap valves 136, 138, 140 and 142 connected in the manner shown in FIG. 8b. Each of these features is represented by an object 262 in vector graphics file 222 received by the client software of the user's client computer 6. Each of these objects 262 has a corresponding object 62 received in memory 26 and a corresponding class stored in database 20, respectively. For example, class 32-1, object 62-1 and object 262-1 can represent elbow 104; class 32-2, object 62-2 and object 262-2, can represent pipe 116; and so forth.

The placement, orientation and/or rotation of each feature in drawing 102 is represented by an object 62 of the selected design file 22 received in memory 26. Preferably, each object 62 has a corresponding class 32 stored in database 20 for the selected design file 22. Alternatively, features having similar invariable properties and variable properties can be represented by a single class 32 for the selected design in database 20. To account for the differences in the variable properties, plural objects 62 can be instantiated in memory 26 for the selected design file 22 from a single class 32 stored in database 20 for the selected design file 22, with the variable properties of each object 62 modified accordingly. For example, elbows 104, 106, 108, and 110 are essentially the same feature rotated at different angles. Thus, for the selected design 22 stored in database 20, one class can store the data in code for an elbow, e.g. 104, in one orientation. To generate the object in memory 26 for this elbow, the server software instantiates an object 62 in memory 26 corresponding exactly to the class 32 stored in database 20 for the selected design 22. Next, the server software instantiates an object 62 which represents elbow 106. To instantiate this object 62, the server software first instantiates an object from the class for elbow 104. The server software then modifies the variable data of the object 62 in a manner which causes the resultant object 62 to contain data and code for elbow 106 in the orientation shown in drawing 102. In a similar manner, objects 62 can be instantiated for elbows 108 and 110 from the class 32 for elbow 104 simply by modifying the variable data in the object 62 created from the class 32 for elbow 104.

In addition to orientation, i.e. rotation, of features having common properties, features, such as pipes 116-124, can have their lengths adjusted as necessary by changing the variable data in the objects 62 therefor. Thus, one class 32 representing elbow 104 can be utilized to instantiate four objects 62 for elbows 104-110; one class 32 representing tee 112 can be utilized to instantiate two objects 62 for tees 112 and 114; one class 32 for pipe 116 can be used to instantiate five objects 62 for pipes 116-124; one class 32 for regulator 126 can be used to instantiate two objects 62 for regulators 126 and 128; one class 32 for plug valve 130 can be used to instantiate three objects 62 for plug valves 130-134; and one class 32 for tap valve 136 can be utilized to instantiate four objects 62 for tap valves 136-142.

In order to generate drawing 102 with the various features placed and aligned as shown, each object 62 stored in memory 26 includes variable data for two or more connection points that enables each feature to be aligned with its adjacent feature. For example, as shown in FIG. 8c, elbow 104 includes connection points 150 and 152 at opposite ends of the axis thereof; pipe 116 includes connection points 154 and 156 at opposite ends of the axis thereof; and tee 112 includes connection points 158 and 160 at opposite ends of the axis extending between the shoulders of tee 112, and connection point 162 at an end of the axis of the base of tee 112 opposite the shoulders of tee 112.

In order to place and align the various features of drawing 102, the server software initially selects one of the objects 62 as a reference object and designates the remaining objects 62 for the design file 22 as objects to be connected, i.e. connection objects, to the reference object. For example, in FIG. 8c, assume that the server software selects object 62 representing elbow 104 as the reference object. The server software modifies variable data of object 62 representing elbow 104 so that the remaining features of the piping/plumbing system will fit into and be centered in an allotted space on display 10 of client computer 6. Once the position of the reference object representing elbow 104 has been determined, the server software changes the variable data of the connector object 62 representing pipe 116 so that connection point 154 is coincident with, or closely adjacent, reference point 152.

The server software also changes the variable data of the object 62 representing tee 112 so that in drawing 102, connection point 158 of tee 112 is coincident with, or closely adjacent to, connection point 156 of pipe 116. In a similar manner, variable data of the objects 62 representing the remaining features of drawing 102 are changed so that the features of drawing 102 are positioned as shown when drawing 102 is displayed on display 10 of client computer 6.

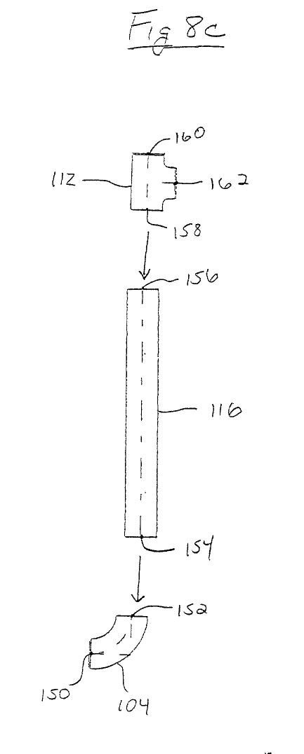

With reference to FIG. 9, and with continuing reference to all previous Figs., the description thus far has focused on the generation of drawing 102 on display 10 of client computer 6, where drawing 102 has a predetermined size and features, or components. However, it may be desirable to adjust a trait, such as the length and/or the height of a component and/or the components comprising the piping/plumbing system of drawing 102 for various reasons. To this end, once drawing 102 is displayed on the display 10 of client computer 6, the client software displays a design modification pull down menu 168 having a display field 170 for displaying predetermined design modifications. Assuming, for example, that the user wishes to change the overall length of the piping/plumbing system shown in drawing 102, the user selects Overall Length in pull down menu 168. In response to selecting Overall Length in pull down menu 168, the client software displays a list (not shown) of options or range of allowable options from which the user can select or enter the desired change in the overall length. Thereafter, the user activates a Select button 172. In response to activating Select button 172, the client software communicates the desired change to the server software via Internet 8.

The server software processes this desired change and generates changes to variable data of one or more objects 62 as required to effect the desired change requested by the user of client computer 6. More specifically, the server software instantiates in memory 26 a new version of the selected design file 22 with the variable data of one or more objects 62 thereof modified to effect the change in the overall length requested by the user of client computer 6. Thereafter, the software layer of the server software processes the new design file 22 to generate a new vector graphics file 222, including a second set of objects 262 corresponding to the objects 62 of the new design file 22, but including the necessary data and code to render new drawing 176 on display 10 of client computer 6.

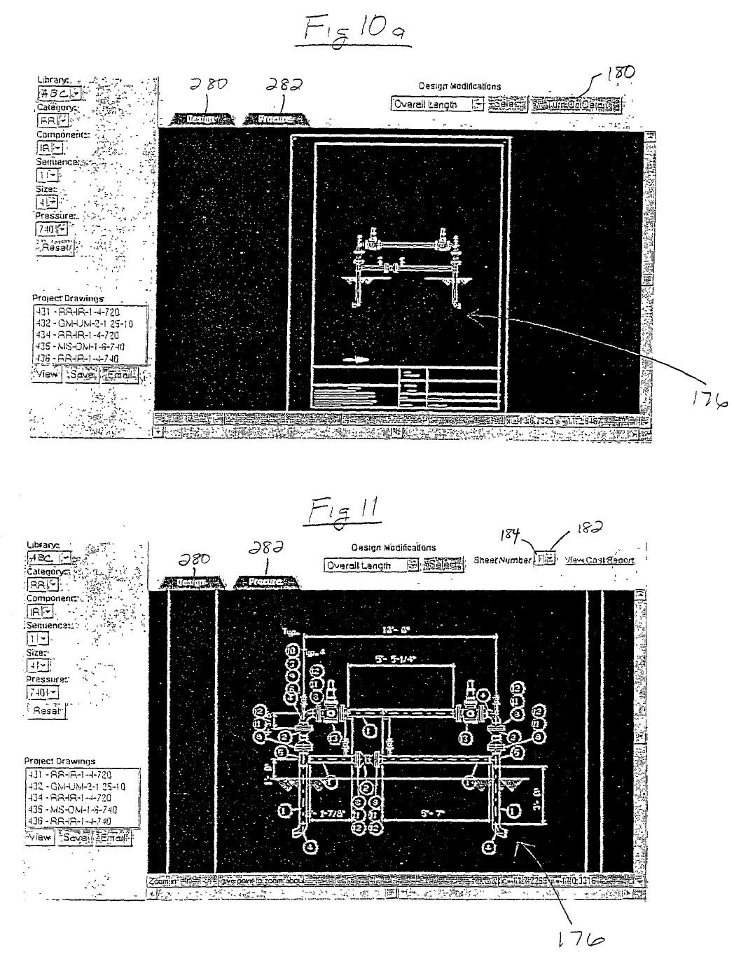

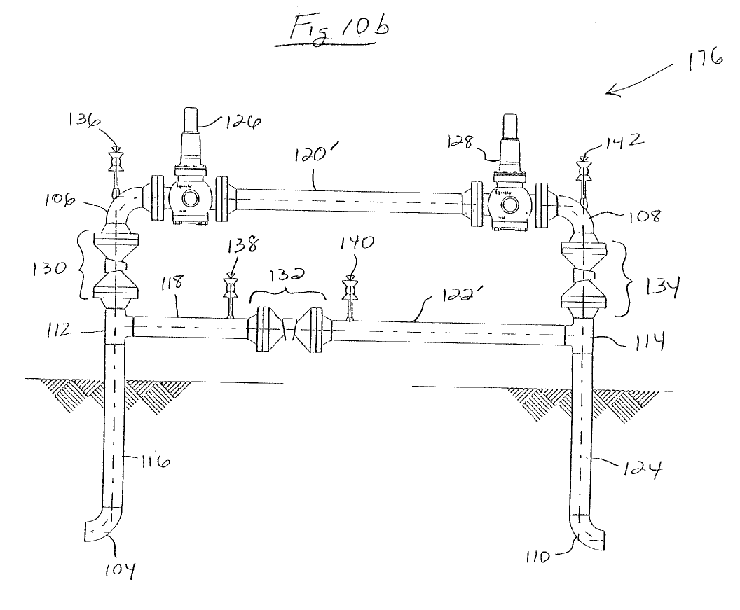

More specifically, as shown in FIG. 10b , the server software modifies the objects 62 representing pipe 120 and pipe 122, so that the corresponding objects 262 of the new vector graphics file 222 processed by the client software produces pipes 120′ and 122′ having longer lengths than pipes 120 and 122, respectively. Thus, by simply modifying the objects 62 representing pipes 120 and 122 in drawing 102, the client software includes in new drawing 176 pipes 120′ and 122′ having lengths longer than the lengths of pipes 120 and 122. In this manner, in new drawing 176, the overall length of the piping/plumbing system can be modified, e.g. increased, over the length of the piping/plumbing system shown in 102.

Alternatively, each design file 22 included in database 20 includes a first set of classes , e.g. 32-1, 32-2, . . . , 32-10, which represent a predetermined design and one or more other classes, e.g. 32-11, 32-12, . . . , 32-x, which represent variations of the predetermined design. When a user stationed at a client computer 6 selects a design file 22 stored in database 20, the server software causes processor 24 to create in memory 26 an instance of each class 32 of the design file 22. Thus, for example, if the user selects design file 22-1, processor 24 creates an instance of each class 32-1, 32-2, . . . , 32-x as an object 62-1, 62-2, . . . , 62-x, respectively, in memory 26. In addition, processor 24 copies data fields 34, 36 and 38 associated with each class of design file 22-1 into memory 26 as data field 64, 66 and 68. In response to the initial instantiation of objects 62 of design file 22-1 in memory 26, the software layer of the server software processes a first set of objects, e.g. 62-1, 62-2, . . . , 62-10, corresponding to the first set of classes 32-1, 32-2, . . . , 32-10 representing the predetermined design, into a vector graphics file 222. The server software then transfers this vector graphics file 222, including a first set of objects, 262-1, 262-2, . . . , 262-10, corresponding to the first set of objects 62-1, 62-2, . . . , 62-10, to the client software running on client computer 6 which produces therefrom a drawing, e.g. drawing 102, of the piping/plumbing system represented in the design file 22 selected by the user in pull down menu 78-68.

In this embodiment, if the user wishes to change a trait, e.g. overall length, of a feature of the piping/plumbing system shown in drawing 102, the user selects this trait in pull down menu 168. The client software then displays a list (not shown) of options or range of allowable options from which the user can select or enter a desired change in the trait. Thereafter, the user activates Select button 172. In response to activating Select button 172, the client software communicates the desired change to the server software via internet 8.

The server software processes this desired change by (i) replacing one or more objects 62 of the first set of objects 62-1, 62-2, . . . , 62-10, with one or more of the other objects 62-11, 62-12, . . . , 62-x included in the design file 22 stored in memory 26, or (ii) adding one or more of the other objects 62-11, 62-12, . . . , 62-x to the first set of objects 62-1, 62-2, . . . , 62-10. For example, the length of a pipe, e.g. 116, can be changed simply by replacing the corresponding object, e.g. 62-2, in the first set of objects, with another object, e.g. 62-12, which represents pipe 116 having a desired length, to form a second set of objects. Alternatively, or in addition to, replacing one or more objects in the first set of objects with one or more of the other objects, the server software can form a second set of objects which includes one or more of the other objects, e.g., 62-11, 62-13, . . . , added to the first set of objects 62-1, 62-2, . . . , 62-10, with the one or more other objects included to represent additional features added to the predetermined design. For example, the predetermined design can include pipes 116 and 118 connected end-to-end by welding. In a modification of this predetermined design, the second set of objects can be formed by adding another object, e.g. 62-11, to the first set of objects 62-1, 62-2, . . . , 62-10. This other object 62-11 can, for example, represent a flange (not shown) between pipes 116 and 118.

Once the server software determines the second set of objects 62, the software layer of the server software processes these objects 62, along with the descriptions 64, notes 66 and cost 68 of the design file 22 received in memory 26, into a new vector graphics file 222. The server software then transfers this new vector graphics file 222, including a second set of objects 262, corresponding to the second set of objects 62 stored in memory 26, to the client software running on client computer 6.

Upon receipt of either of the new vector graphics file 222, discussed above, including the second set of objects 262, the client software processes the new vector graphics file 222 and generates therefrom new drawing 176 on display 10 of client computer 6.

If additional design changes are necessary, the user can make these design changes in the manner described above in connection with the change of the piping/plumbing system from the length shown in drawing 102 to the length shown in new drawing 176. Once the user is satisfied with the design, the user can select a Turn on Detail button 180 shown in FIG. 10a. In response to selecting this button, the client software generates from the new vector graphic file 222 the dimensions, lead lines and/or numbered circles, or balloons, on drawing 176 as shown in FIG. 11.

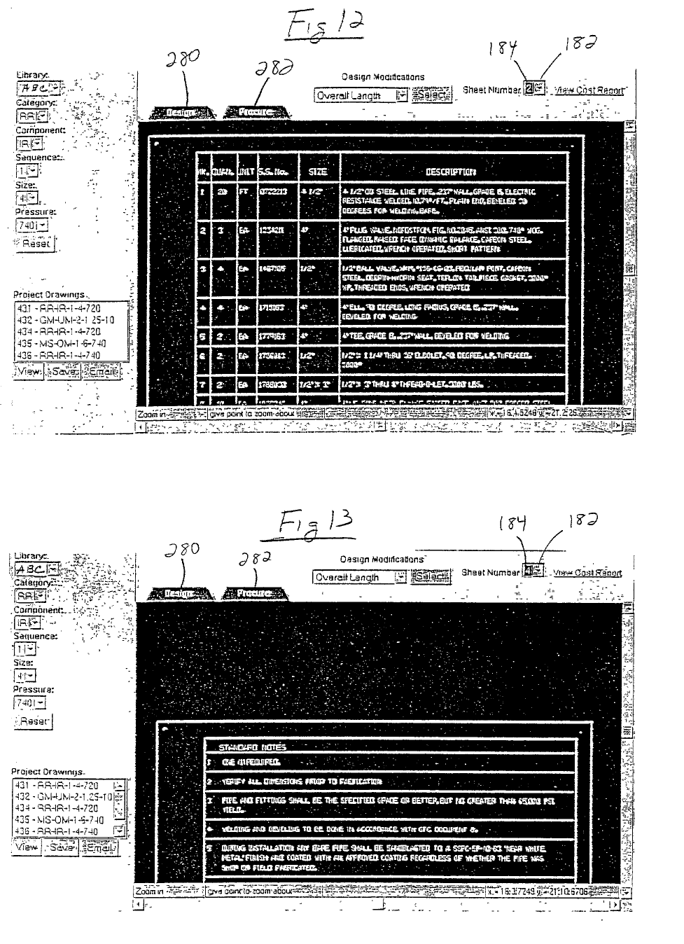

With reference to FIG. 12, and with continuing reference to all previous Figs., when a Design tab 280 is selected, in response to the user selecting the Turn on Detail button 180, in FIG. 10a, the client software, in addition to displaying on new drawing 176 the dimensions, lead lines and/or numbered circles shown in FIG. 11, also displays on display 10 of client computer 6 a Sheet Number pull down menu 182 having a display field 184 for displaying a number associated with the drawing or data to be displayed on display 10 of client computer 6. For example, as shown in FIG. 11, when display field 184 of pull down menu 182 includes sheet number 1, new drawing 176 including the dimensions, lead lines and/or numbered circles, shown is displayed on display 10 of client computer 6. As shown in FIG. 12, when display field 184 of pull down menu 182 includes sheet number 2, various bill-of-material (BOM) description data, included in the new vector graphics file 222 received by client computer 6 and related to the features associated with the numbered circles shown in FIG. 11, are displayed on display 10 of client computer 6. Depending on the number of features included in new drawing 176 and the length of the description data for each feature, the description data shown in FIG. 12 can extend for more than one page.

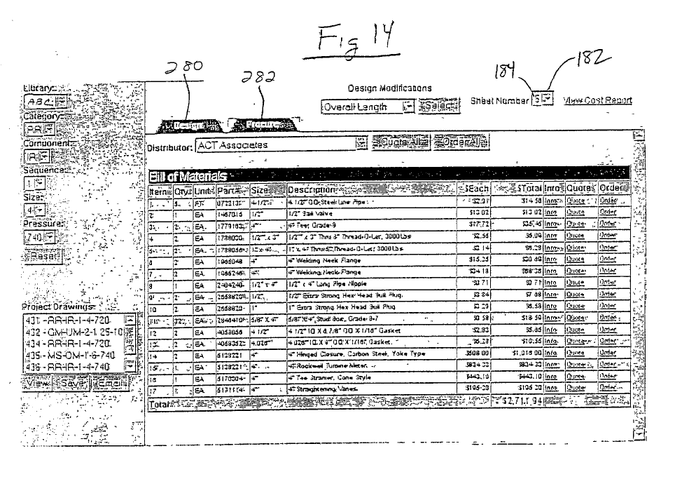

As shown in FIG. 13, when display field 184 of pull down menu 182 includes sheet number 4, note data included in the new vector graphics file 222 received by client computer 6 is displayed on display 10 thereof. This note data can include note data for each feature of new drawing 176 or can include note data generic to the entire piping/plumbing system shown in new drawing 176.

Lastly, as shown in FIG. 14, when a Procure tab 282 is selected, the client software displays in tabular form various bill-of-material (BOM) data, such as quantity, part number, price, etc., of the features of the piping/plumbing system in new drawing 176 associated with the numbered circles shown in FIG. 11.

As can be seen, the present invention provides an Internet based system and method for generating new or modified design drawings from a database of predetermined designs.

The invention has been described with reference to the preferred embodiments. Obvious modifications and alterations will occur to others upon reading and understanding the preceding detailed description. For example, the sheet numbers shown in display field 184 of pull down menu 182 in FIGS. 11-14 are for illustration purposes and are not to be construed as limiting invention. In addition, while the invention has been described in connection with changing the length and/or height of a predetermined design, and/or the addition of a component to the predetermined design, the invention can also be utilized to change a predetermined design to include components having different pressure ratings, tap sizes, number of taps, component types, components rotation, tee branch sizes, component placement distances and/or overall setting lengths by which the length of other components are calculated. It is intended that the invention be construed as including all such modifications and alterations insofar as they come within the scope of the appended claims or the equivalents thereof.

I claim:

1. A design/drafting method implemented between a client computer and a server computer connected to each other via the Internet, the method comprising the steps of:
(a) providing at a server computer a database having a plurality of design files, each design file representing a design and including a plurality of classes, each class representing a feature of a design represented by the corresponding design file;
(b) selecting at a client computer via the Internet a design file from the database at server computer;
(c) instantiating in a memory of the server computer from the plurality of classes in the database for the selected design file a plurality of objects including a reference object and at least one connector object, each object including at least two connection points;
(d) determining in the memory of the server computer where one of the connection points of the connector object is coincident with or closely adjacent one of the connection points of the reference object; and
(e) displaying on a display of the client computer as a function of the reference object and the connector object a drawing of the design with the one connection point of the connector object coincident or closely adjacent the one connection point of the reference object.

2. The method as set forth in claim 1, further including the steps of:
converting each object in memory from a first type to a second type;
transferring the objects of the second type from the memory of the server computer to the client computer; and
processing the objects of the second type received by the client computer, wherein step (e) further includes displaying on the display of the client computer the features represented by the second type objects of the reference object and the connector object.

3. The method as set forth in claim 1, wherein the drawing of the design includes for the reference object and the connector object a first drawing part and a second drawing part, respectively, with the first and second drawing parts positioned relative to each other in the drawing as a function of the server computer determining where the one connection point of the connector object is coincident with or closely adjacent the one connection point of the reference object.

4. The method as set forth in claim 1, wherein:
step (c) further includes instantiating another connector object;
step (d) further includes determining where another connection point of the connector object is coincident with one connection point of the other connector object; and
step (e) further includes generating from the reference object, the connector object and the other connector object, a drawing of the design with the other connection point of the other connector object coincident with the one connection point of the connector object.

5. The method as set forth in claim 4, wherein the drawing of the design includes for the reference object, the connector object and the other connector object a first drawing part, a second drawing part and a third drawing part, respectively, with the first, second and third drawing parts positioned relative to each other in the drawing as a function of the server computer determining where the one connection point of the connector object is coincident with the one connection point of the reference object and where the other connection point of the connector object is coincident with the one connection point of the other connector object.

6. The method as set forth in claim 5, wherein the reference object and each connector object includes a plurality of invariable data, with each invariable data related to an invariable trait of the corresponding feature of the drawing.

7. The method as set forth in claim 6, wherein at least one of the connector objects includes at least one variable data, with the variable data related to a variable trait of the corresponding feature of the drawing.

8. The method as set forth in claim 7, wherein the variable data relates to a length of a feature generated from the one of the connector objects.

9. The method as set forth in claim 8, further including the step of receiving at the server computer from the client computer via the Internet a change in the variable data of the trait of the reference object or one of the connector objects, wherein step (e) further includes the step of displaying the drawing of the design with the second or third drawing including a feature having a trait varied in accordance with the change in the variable data.

10. A server computer connectable to the Internet, the server computer comprising:
a database of design files, each design file including a plurality of classes;
a processing routine for receiving from the Internet the selection of one design file from the database, for instantiating from the plurality of classes for the selected design file a plurality of objects, each object representing a feature of a design represented by the selected design file, with each object having a plurality of connection points for its feature, and for determining for the feature represented by each object where at least one connection point is coincident or closely adjacent a connection point of the feature represented by another object; and
a data transfer routine for transferring to the Internet the data related to each object for display of a drawing including the features represented by the objects whereby the features represented by the objects are arranged to form the drawing with at least one connection point of each feature connected to a connection point of another feature as a function of the coincident connection points in the corresponding objects representing the features.

11. The server computer as set forth in claim 10, wherein the processing routine is configured to modify a connection point of an object that is not coincident with the connection point of another object so that their connection points are coincident in the display of the drawing.

12. The server computer as set forth in claim 10, wherein:
the processing routine receives via the Internet change data for modifying a trait of one of the objects;
in response to receiving the change data, the processing routine changes data of the one object to effect a change in the trait thereof; and
the drawing includes the feature represented by the one object with the trait varied in accordance with the change data.

13. The server computer as set forth in claim 12, wherein the change data modifies one of a length and a height of the feature represented by the one object.

14. The server computer as set forth in claim 10, wherein:
each design file further includes alpha, numeric and/or alphanumeric data related to at least one feature represented by one of the objects; and
the data transfer routine transfers to the Internet the alpha, numeric and/or alphanumeric data related to the at least one feature represented by one of the objects of the design file.

15. A client computer connectable to the Internet, the client computer comprising:
an interface routine for selecting via the Internet one of a plurality of predetermined design files, each design file including a plurality of objects, each object representing a feature of the design represented by the design file, for receiving from the Internet in response to the selection of the design file a first set of objects, for selecting from the Internet one or more modifications to the design file, for transmitting the one or more modifications to the Internet and for receiving from the Internet in response thereto a second set of objects representing features of the design file with at least one object of the second set modified as a function of the one or more transmitted modifications; and
a display routine for displaying a menu of the plurality of predetermined design files used by the interface routine for selecting the one predetermined design file, for displaying a first drawing including the features of the selected design file from the first set of objects received from the Internet, for displaying a menu used by the interface routine for selecting the one or more modifications to the selected design file and for displaying a second drawing of the features of the selected design file from the second set of objects received from the Internet with at least one feature of the second drawing modified from the first drawing as a function of the selected one or more modifications.

16. The client computer as set forth in claim 15, wherein:
the selected design file includes alpha, numeric and/or alphanumeric data related to features of the first and/or second drawings displayed by the display routine; and
the display routine displays a menu used by the interface routine for selecting the alpha, numeric and/or alphanumeric data related to the selected design file to be displayed by the display routine.

17. The client computer as set forth in claim 15, wherein the alpha, numeric and/or alphanumeric data includes at least one of a description, a note and a cost related to one or more features of the design file.

18. The client computer as set forth in claim 15, wherein:
each feature of the design file includes at least two connection points; and
the display routine displays the features of the design file with one connection point of each feature coincident or closely adjacent a connection point of another feature.
